(19) United States
(12) Patent Application Publication
(10) Pub. No.: US 2015/0050073 A1
(43) Pub. Date: Feb. 19, 2015

(54) APPARATUS FOR MOUNTING HANDLEBARS

(71) Applicant: Robert Forgrave, Kirkland, WA (US)

(72) Inventor: Robert Forgrave, Kirkland, WA (US)

(21) Appl. No.: 14/364,297

(22) PCT Filed: Dec. 11, 2011
(86) PCT No.: PCT/US11/64295

§ 371 Date: Oct. 4, 2014

(51) Int. Cl. B62K 21/18

(52) U.S. Cl. CPC B62K 21/18
USPC 403/188

(57) ABSTRACT

An apparatus for mounting a handlebar or handlebars to a vehicle using a handlebar or handlebars for steering, pulling or otherwise imparting control to the vehicle. The apparatus has a first component for coupling with the vehicle, a second component for receiving a handlebar, a center mount pin rotatably coupling the first component to the second component, a tension device and a lock pin for locking the first and second components at a particular angle of rotation. When the lock pin is pulled, disengaging the lock pin from a portion of the apparatus, the tension device rotates the handlebar about the center mount pin. A ramp may be present in the channel that receives the lock pin, the ramp joining the tension device in having a tendency to rotate the handlebars to a storage position. Varied positions for the lock pin are possible, giving an aerodynamic appearance to certain embodiments.

### FIELD OF THE INVENTION

This invention relates generally to handlebars, and more specifically, to an apparatus for mounting a handlebar or handlebars.

### BACKGROUND

Technical material which can be regarded as useful for the understanding, searching and examination of the invention includes:

GB 503 237 A (Horace William Neale), “Improvements in or relating to the Handlebars of Cycles,” 1939.

U.S. Pat. No. 4,582,509 A (Takamiya Kikuzo), “Adjustable Handlebar for Bicycle,” 1987.

U.S. Pat. No. 5,755,141 A (Chen Chao-Hu), “Means for Adjusting Positions of a Bicycle's Handlebar,” 1998.

U.S. Pat. No. 5,241,881 A (Chen Chao F), “Handlebar Assembly for Cycles,” 1993.

U.S. Pat. No. 1,413,463 A (Filor), “Adjustable Handle Bar for Bicycles,” 1922.

WO2010/166328 A1 (Alan McLaughlin et al), “A Mounting Device for Mounting a Handlebar to a Handlebar Stem of a Bicycle,” 2010.

WO2007/148202 A2 (Stefano Cavicchi), “Device for Turning a Bicycle Steering Handlebar to a Parking Position,” 2007.

WO2007/023314 A1 (Jonathan Hudson), “A Bicycle Having a Foldable Handlebar Stem,” 2007.

WO2004/048186 A1 (Silvio Volpatti), “Structure of Handle-Bars,” 2004.

WO2000/029279 (Lucas Meuwese), “Cycle,” 2000.

US2010/0207352 (Che-Wei Hsu), “Foldable Device for Connecting a Front Form to a Handlebar of a Bicycle,” 2010.

US2010/0148467 (Martin Hoerdum), “Collapsible Bicycle,” 2010.

US2010/0132502 A1 (Alejandro Lacreu), “Quick Release Stem,” 2010.

US2007/0277641 A1 (Versey), “Steering Apparatus,” 2007.

U.S. Pat. No. 7,740,264 B2 (Lacreu), “Quick Release Stem,” 2010.

U.S. Pat. No. 7,571,919 (Wu), “Positioning Device for a Bicycle Handlebar,” 2009.

U.S. Pat. No. 7,353,731 B2 (Lin), “Quick Release Handlebar Stem Assembly for a Bicycle,” 2008.

U.S. Pat. No. 7,296,813 B2 (Montague), “Manually Height Adjustable and Rotatable Steering Assembly for Bicycles,” 2007.

U.S. Pat. No. 7,243,573 B2 (Bass), “Folding Handlebar,” 2007.

U.S. Pat. No. 7,242,144 B2 (Colman), “Folding Bicycle,” 2007.

U.S. Pat. No. 6,968,754 B2 (Bandarra), “Space Maximizing Means for Keeping or Storing Bicycles,” 2005.

U.S. Pat. No. 6,941,835 B2 (Ying), “Overturning and Folding Device for Handlebar,” 2005.

U.S. Pat. No. 6,920,806 B2 (Cutsforth), “Handlebar Mounting Apparatus,” 2001.

U.S. Pat. No. 6,637,288 B2 (Chu), “Compact Folding Handle Bar Apparatus for Bicycle,” 2003.

U.S. Pat. No. 6,623,023 B2 (Niitsu), “Bicycle and Bicycle Folding Method,” 2003.

U.S. Pat. No. 6,619,683 B1 (Lin), “Front-Fork Telescoping Bicycle Handlebar Assembly,” 2003.

U.S. Pat. No. 6,581,492 B1 (Chen), “Handle Folding Structure for a Foldable Bicycle,” 2003.

U.S. Pat. No. 6,273,442 B1 (Fallon), “Folding Two Wheeled Vehicle,” 2001.

U.S. Pat. No. 5,743,153 (Valentino), “Bicycle Handlebar Stabilizer,” 1998.

U.S. Pat. No. 5,727,427 (Nien), “Pivotable Handlebar Stem,” 1998.

The listing of technical material above is only intended to satisfy PCT Article 5.1(a)(ii). Nothing in any of the references should be viewed as casting any limitation on the subject matter of the instant application, including but not limited to application to a bicycle, or application to a handlebar or handlebars. The material is presented solely pursuant to PCT requirements for the understanding, searching and examination, but not for limiting the scope, of the invention. The technical material has no bearing on post-issuance proceedings.

The content of the technical material may describe various devices for moving handlebars out of what is commonly considered a “riding position.” However, the devices described in the technical material have not sufficiently addressed the needs of users. The references may lack, for example, a device for moving handlebars where the device assists the movement, or a device for and/or locking or biasing the handlebars into a particular position other than the riding position for storage/carrying, or where components of the device are internal to avoid pinched fingers during the movement, or where the device keeps a low-profile or aerodynamically high-performance or visually appealing appearance, or where the device incorporates additional safety mechanisms, or where the device mates easily with a steering tube.

### SUMMARY

This invention relates generally to handlebars, and more specifically, to an apparatus for mounting a handlebar or handlebars. In some embodiments, an apparatus for mounting a handlebar is coupled with a handlebar and a vehicle. In some embodiments, a vehicle may be a bicycle. In some embodiments, an apparatus for mounting a handlebar has a stem, a handlebar mount, a center mount pin and a tension device. A center mount pin may rotatably couple a stem and a handlebar mount. A handlebar mount may further have a lock pin, the lock pin operable to engage at least a portion of the stem. A tension device may tensionally bias the stem and handlebar mount, the tension device having a tendency to rotate the handlebar mount about the center mount pin.

In some embodiments, the rotation of the handlebar mount and handlebar may rotate the handlebar from a riding position to a storage position. A lock pin may be operated disengaging the lock pin from at least a portion of the stem so that the handlebar may be rotated, after which the lock pin may be released re-engaging the lock pin with at least a portion of the stem. A stem may have a tubular member for receiving a steering tube of a bicycle. A stem may have a tension channel in which a tension device is disposed, the tension channel having a stem tension coupling. A handlebar mount tension coupling is disposed such that when the stem and handlebar mount are coupled, the handlebar mount tension coupling is positioned within the tension channel such that a tension device may be coupled to the stem tension coupling and handlebar mount tension coupling and tensionally bias the handlebar mount to rotate about the center mount pin relative to the stationary stem.

In some embodiments, a stem may have a lock pin channel, the lock pin channel having one or more preferred positions which may include a riding position lock hole and a storage position lock hole. In some embodiments, a lock pin is tensionally biased to engage the lock pin channel and when the handlebar is rotated to certain preferred positions, the lock pin tensional bias may engage the riding position lock hole or storage position lock hole.

### BRIEF DESCRIPTION OF THE DRAWINGS

Embodiments of the present invention are described in detail below with reference to the following drawings:

FIGS. 1a and 1b are a side view and a detailed side view of an apparatus for mounting a handlebar or handlebars, in accordance with an embodiment of the invention;

FIGS. 2a, 2b and 2c are perspective views of an apparatus for mounting a handlebar or handlebars, in accordance with an embodiment of the invention;

FIGS. 2d and 2e are top views of an apparatus for mounting a handlebar or handlebars, in accordance with an embodiment of the invention;

FIG. 2f is a side view of an apparatus for mounting a handlebar or handlebars, in accordance with an embodiment of the invention;

FIGS. 3a and 3b are perspective views of an apparatus for mounting a handlebar or handlebars, in accordance with an embodiment of the invention;

FIG. 3c is a side view of an apparatus for mounting a handlebar or handlebars, in accordance with an embodiment of the invention;

FIGS. 3d and 3e are top views of an apparatus for mounting a handlebar or handlebars, in accordance with an embodiment of the invention;

FIG. 3f is a bottom view of an apparatus for mounting a handlebar or handlebars, in accordance with an embodiment of the invention;

FIG. 4a is an exploded perspective view of an apparatus for mounting a handlebar or handlebars, in accordance with an embodiment of the invention;

FIG. 4b is a perspective view of an apparatus for mounting a handlebar or handlebars, in accordance with an embodiment of the invention;

FIG. 4c is a top view of an apparatus for mounting a handlebar or handlebars, in accordance with an embodiment of the invention;

FIG. 4d is an exploded perspective view of an apparatus for mounting a handlebar or handlebars, in accordance with an embodiment of the invention;

FIGS. 4e and 4f are exploded side and bottom view of an apparatus for mounting a handlebar or handlebars, in accordance with an embodiment of the invention;

FIGS. 4g and 4h are a bottom view and a sectional view of an apparatus for mounting a handlebar or handlebars, in accordance with an embodiment of the invention;

FIGS. 5a and 5b are a perspective view and a side view of an alternate embodiment of an apparatus for mounting a handlebar or handlebars, in accordance with an embodiment of the invention;

FIGS. 6a and 6b are an exploded perspective view and an exploded view of an apparatus for mounting a handlebar or handlebars, in accordance with an embodiment of the invention; and

FIGS. 7a and 7b are bottom views of an apparatus for mounting a handlebar or handlebars, in accordance with an embodiment of the invention.

### DETAILED DESCRIPTION

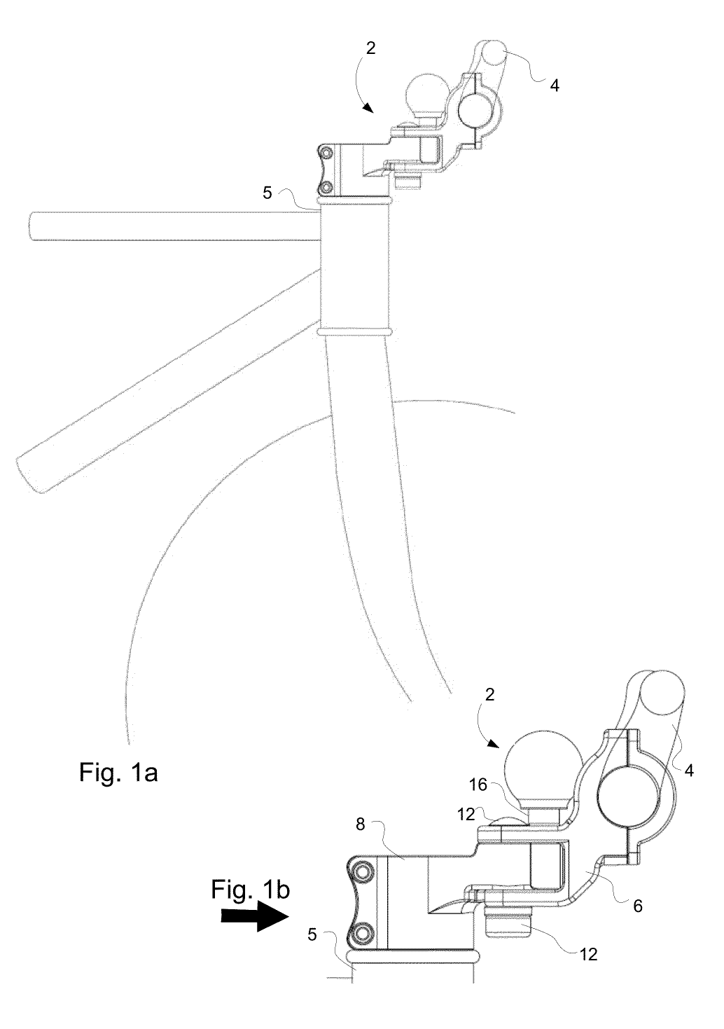

This invention relates generally to handlebars, and more specifically, to an apparatus for mounting a handlebar or handlebars. Specific details of certain embodiments of the invention are set forth in the following description and in FIGS. 1-7 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1a is a side view of an apparatus for mounting a handlebar or handlebars, in accordance with an embodiment of the invention. FIG. 1b is a detail view of a portion of FIG. 1a, in accordance with an embodiment of the invention. In some embodiments, an apparatus for mounting a handlebar 2 is coupled with a handlebar 4 and a vehicle 5. It will be understood by those with skill in the art that the term handlebar as used herein may refer to a one-piece bar with one or more grips. It will additionally be understood by those with skill in the art that the term handlebar as used herein may refer to any bar with one or more grips and/or any bar being comprised of more than one piece. The plural term “handlebars” may in fact refer to a single bar with a plurality of grips or a structure comprised of a plurality of bars and a plurality of grips. Thus, for the purposes of this application, the Applicant intends for the term handlebar or handlebars to be interchangeable and to generally refer to a structure having one or more grips which is generally used to impart control to a vehicle. From here forward, Applicant will use the term handlebar 4 and intends to encompass any structure having one or more grips which is generally used to impart control to a vehicle, whether the structure comprises a single piece with a single grip, a single piece with multiple grips, multiple pieces with a single grip, or multiple pieces with multiple grips.

Further, it will be appreciated by those with skill in the art that the phrase “apparatus for mounting handlebars,” as used in the instant application including in the preamble to the claims, does not limit the function of the apparatus to being a mount, or to being used with handlebars, nor do the terms limit the use of the apparatus to mounting handlebars. Use of the term “apparatus for mounting handlebars” in any claim preambles is not intended to give life, meaning, or vitality to the claims.

In some embodiments, a handlebar 4 is a bar having two ends, the two ends having a grip at or substantially near each of the two ends. In some embodiments, a handlebar 4 is a bar having a grip at or substantially near each of the two ends and another pair of grips, the additional pair of grips being one on each side of the center of the handlebar 4 substantially near the center of the handlebar 4. In yet another embodiment, the handlebar 4 may be gripped along substantially all of the handlebar 4. In some embodiments, the handlebar 4 is substantially straight. In different embodiments, the handlebar 4 is curved. In some embodiments, the handlebar 4 has multiple bars. In some embodiments, the handlebar 4 has secondary bars protruding from a main handlebar 4, some or all of the secondary bars having grips. In some embodiments, the handlebar 4 is a butterfly-style handlebar. In different embodiments, the handlebar 4 is a tiller having a single grip. In still different embodiments, the handlebar 4 is a control yoke. In yet a different embodiment, the handlebar 4 is a steering wheel. Those with skill in the art will understand that there are many structures which are a handlebar 4 within the meaning of the instant application, the structures having different configurations of bars, grips, pulls, pads, shapes, thicknesses or dimensions. From here forward, Applicant will use the term handlebar 4 as an exemplary structure only, but intends to encompass any combination of the above configurations or features which is generally used to impart control to a vehicle.

In some embodiments an apparatus for mounting a handlebar 2 is used with a vehicle 5. For the purposes of this application, a vehicle 5 is any machine that carries a load and for which at least a handlebar 4 is used to impart control to the vehicle 5. In some embodiments, a vehicle 5 is a bicycle. Applicant will use a bicycle from here forward only as an exemplary structure of a vehicle 5 with which an apparatus for mounting a handlebar 2 can be used. However, one with skill in the art will appreciate that there are many machines that carry a load and for which at least a handlebar 4 is used to impart control, control including steering, pulling, pushing or tugging, among others. For example, a moped, motorcycle and a tricycle are all vehicles 6 within the scope of this application. One skilled in the art will recognize that other vehicles having at least a handlebar 4 which imparts control to the vehicle exist. Other examples include a Segway, a pallet jack, a boat, an airplane, a railroad handcar or an automobile.

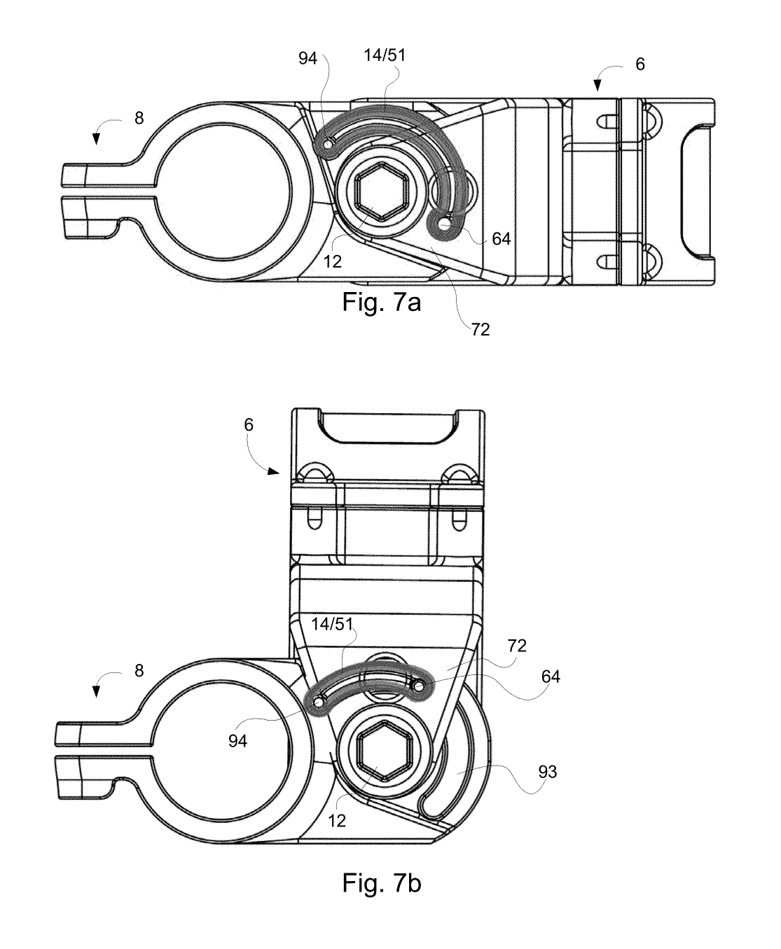

As can be seen in FIG. 1b, in some embodiments, an apparatus for mounting a handlebar 2 has a stem 8, a handlebar mount 6, a center mount pin 12, and a tension device 14 (14 not shown in FIG. 1a or 1b but depicted in FIGS. 7a and 7b). A center mount pin 12 may rotatably couple a stem 8 and the handlebar mount 6. A handlebar mount 6 may further have a lock pin 16, the lock pin 16 being operable to engage at least a portion of the stem 8. A tension device 14 may tensionally bias the stem 8 and handlebar mount 6, the tension device 14 having a tendency to rotate the handlebar mount 6 about the center mount pin 12.

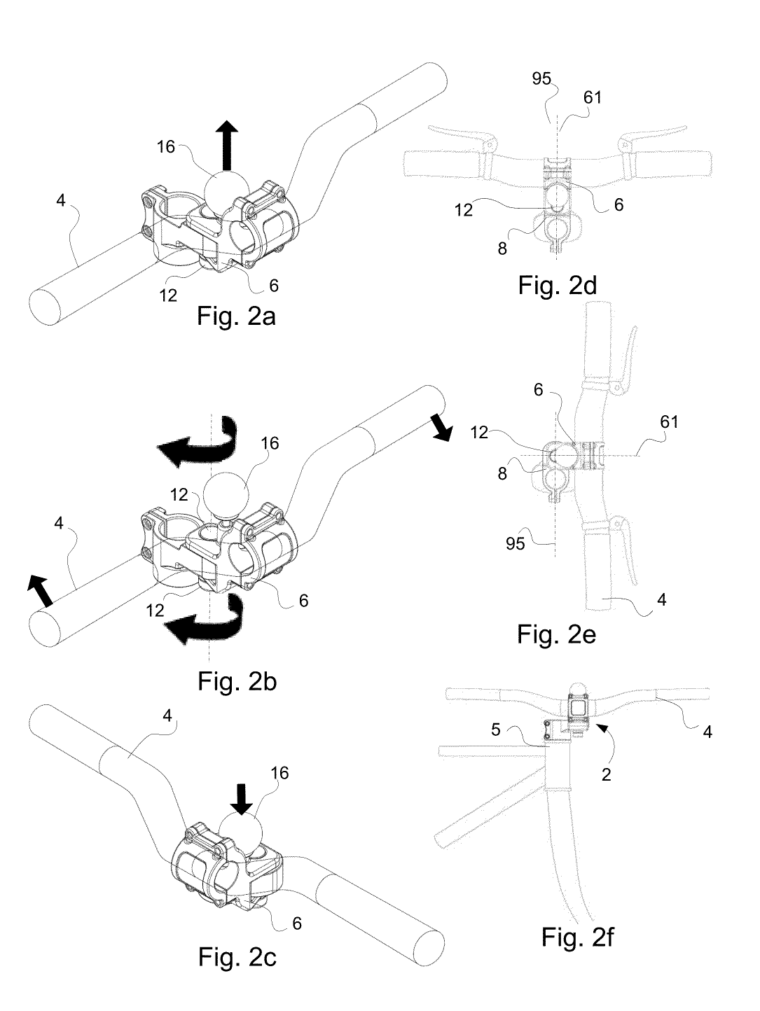

FIGS. 2a, 2b and 2c are perspective views of an apparatus for mounting a handlebar or handlebars, in accordance with embodiments of the invention. In some embodiments, an apparatus for mounting a handlebar 2 is operable to facilitate rotation of the handlebar mount 6 and handlebar 4 about an axis through the center mount pin 12. In some embodiments, the rotation of the handlebar mount 6 and handlebar 4 may, for example, rotate the handlebar mount 6 and handlebar 4 from a “riding position” to a “storage position.” To perform the rotation operation, the lock pin 16 of the handlebar mount 6 is pulled upward as depicted in FIG. 2a, the lock pin 16 disengaging from its engagement with at least a portion of the stem 8. The handlebar mount 6 and handlebar 4 rotate about an axis through the center mount pin 12 as depicted in FIG. 2b. After the handlebar mount 6 and handlebar 4 are rotated, the lock pin 16 of the handlebar mount 6 is lowered, as depicted in FIG. 2c, the lock pin 16 engaging at least a portion of the stem 8.

FIGS. 2d and 2e are top views of an apparatus for mounting a handlebar or handlebars, in accordance with embodiments of the invention. In some embodiments, an apparatus for mounting a handlebar 2 is comprised of a stem 8 and a handlebar mount 6, the stem 8 and handlebar mount 6 having longitudinal axes. In a “riding position,” the longitudinal axis of the stem 95 may be aligned with the longitudinal axis of the handlebar mount 61 as depicted in FIG. 2d. When the handlebar mount 6 and handlebar 4 are rotated about the center mount pin 12, the longitudinal axis of the handlebar mount 61 may no longer be aligned with the longitudinal axis of the stem 95, as the handlebar mount 6 rotates about the center mount pin 12 while the stem 8 remains stationary as depicted in FIG. 2e.

FIG. 2f is a side view of an apparatus for mounting a handlebar or handlebars, in accordance with an embodiment of the invention. FIG. 2f may be compared with FIG. 1a. FIG. 1a depicts a handlebar 4 in an exemplary “riding position” where FIG. 2f depicts a handlebar 4 in an exemplary “storage position,” the handlebar 4 having been rotated relative to the vehicle 5 by the apparatus for mounting a handlebar 2.

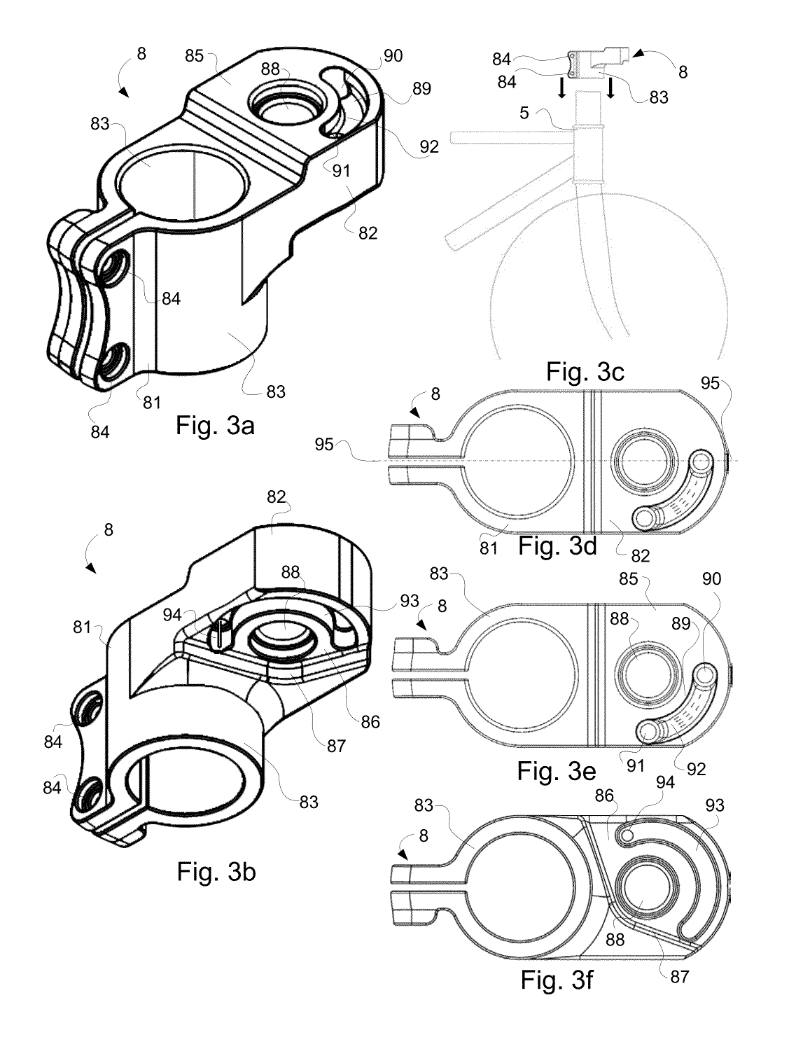

FIGS. 3a and 3b are perspective views of an apparatus for mounting a handlebar or handlebars, in accordance with an embodiment of the invention. FIG. 3c is a side view of an apparatus for mounting a handlebar or handlebars, in accordance with an embodiment of the invention. FIGS. 3d and 3e are top views of an apparatus for mounting a handlebar or handlebars, in accordance with an embodiment of the invention. FIG. 3f is a bottom view of an apparatus for mounting a handlebar or handlebars, in accordance with an embodiment of the invention. As may be best seen in FIG. 3a, 3b or 3d, in some embodiments, an apparatus for mounting a handlebar 2 may have a stem 8, the stem 8 having a clamp section of the stem 81 and a center mount section of the stem 82. As may be best seen in FIG. 3d, a stem may have a stem longitudinal axis 95, the stem longitudinal axis 95 extending from the clamp section of the stem 81 through the center mount section of the stem 82.

As may be best seen in FIGS. 3a and 3b, in some embodiments, a clamp section of the stem 81 may have a tubular member of the stem 83, the tubular member of the stem 83 being configured for receiving a steering tube of a bicycle. A clamp section of the stem 81 may also have one or more lugs of the stem 84, the one or more lugs of the stem 84 configured to receive one or more fasteners, the one or more lugs of the stem 84 being operable to reduce the diameter of the tubular member of the stem 83 when one or more fasteners are received by the one or more lugs of the stem 84. In some embodiments, a clamp section of the stem 81 can couple the apparatus for mounting a handlebar 2 to a vehicle 5 by, for example, lowering the tubular member of the stem 83 over a steering tube of a bicycle as can be seen in FIG. 3c, and coupling one or more fasteners with the one or more lugs of the stem 84, reducing the diameter of the tubular member of the stem 83 such that the stem 8 is clamped to the steering tube of the bicycle. The fasteners may be external to the one or more lugs of the stem 84 or may be integrated with the one or more lugs of the stem 84. Those with skill in the art will realize that many systems and methods for joining a stem 8 to a vehicle 5 exist and are encompassed by this disclosure of the invention.

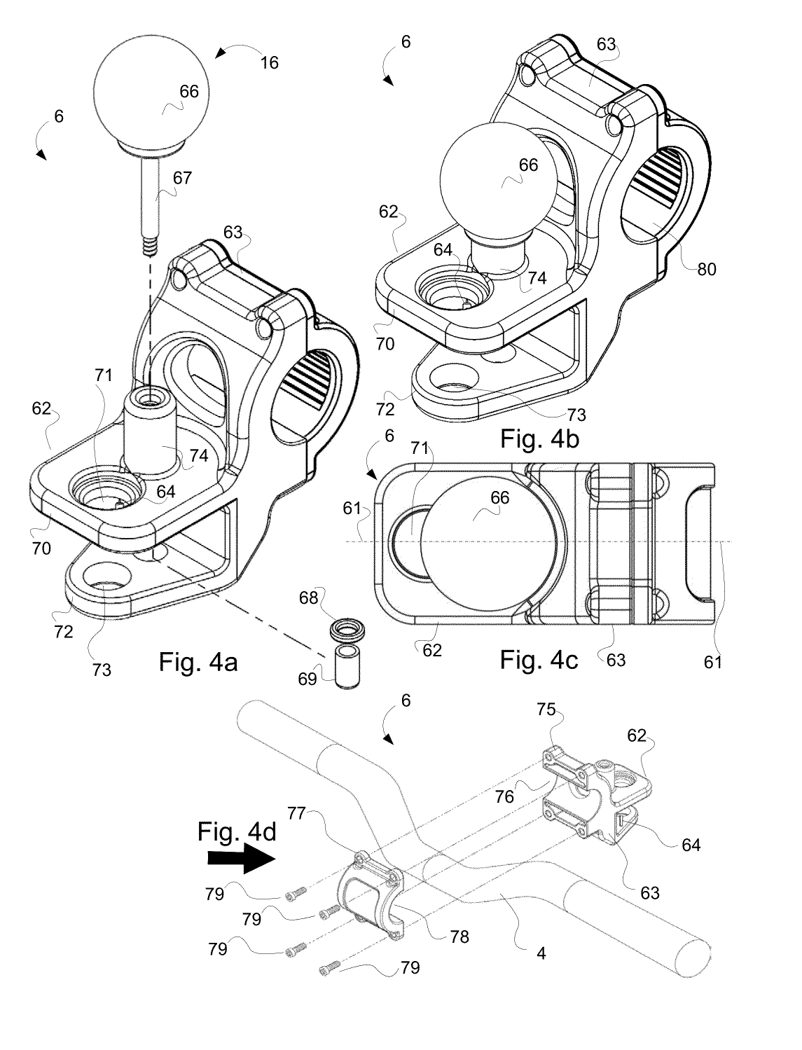

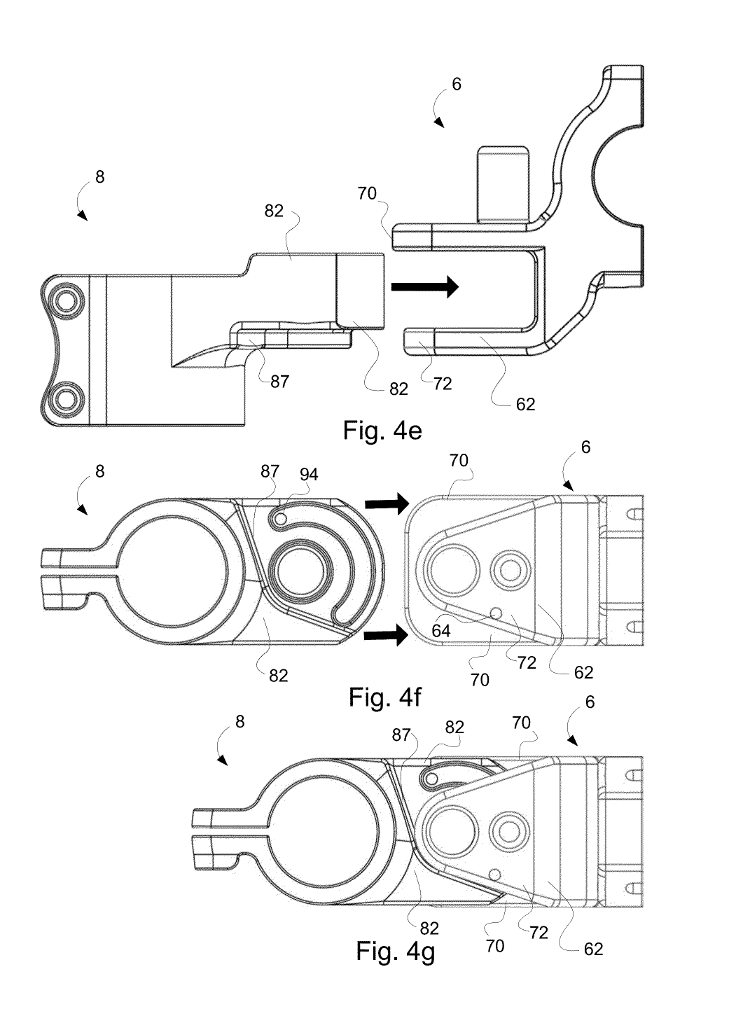

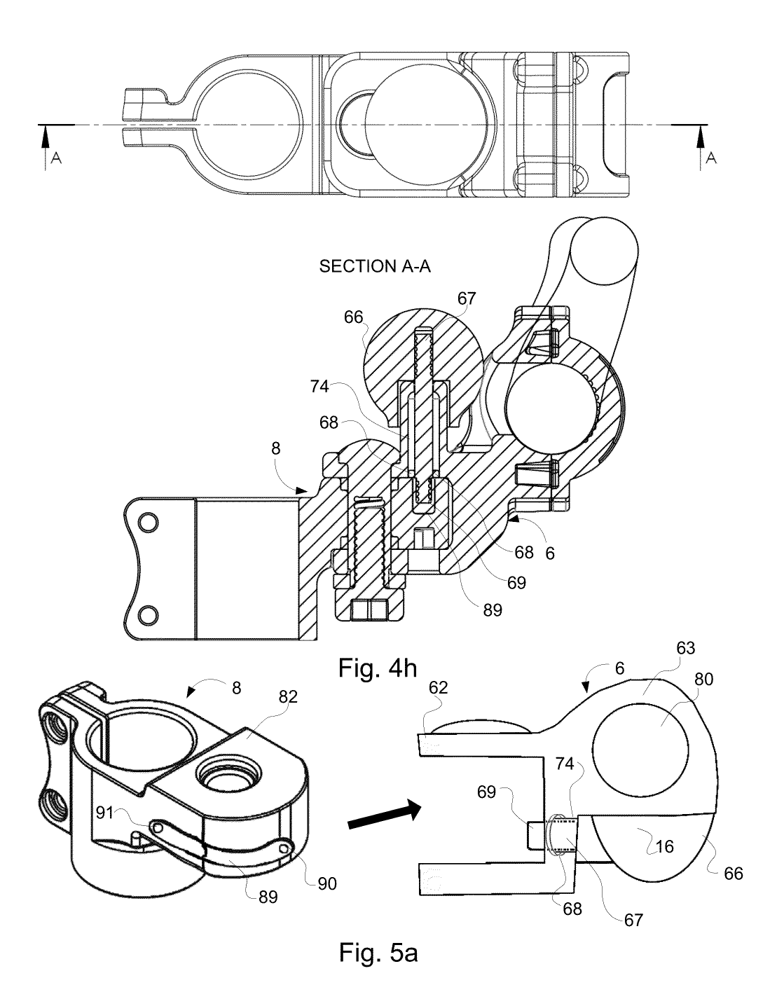

Returning to FIGS. 3a and 3b and adding FIGS. 3d, 3e and 3f to the discussion, in some embodiments the center mount section of the stem 82 may have a top surface of the center mount section of the stem 85, a bottom surface of the center mount section of the stem 86, a shelf of the center mount section of the stem 87, a center pin through hole of the stem 88, a lock pin channel 89, a riding position lock hole 90, a storage position lock hole 91, a ramp 92, a tension channel 93, and a tension coupling of the stem 94. In some embodiments, a center mount pin 12 (12 not shown in FIG. 3a or 3b but depicted in FIG. 1b, inter alia) is used to couple a stem 8 and a handlebar mount 6, the center mount pin 12 disposed through the center pin through hole of the stem 88 (as well as the center pin through holes of the handlebar mount 71 and 73, not shown in FIG. 3a or 3b but shown in FIG. 4a), the center mount pin 12 passing through the aperture in the top surface of the center mount section of the stem 85 formed by the center pin through hole of the stem 88, and the center mount pin 12 passing through the aperture in the bottom surface of the center mount section of the stem 86 formed by the center pin through hole of the stem 88.

In some embodiments, the bottom surface of the center mount section of the stem 86 may have a portion cut away such that the bottom surface of the center mount section of the stem 86 has at least two elevations when viewed from the side. A shelf of the center mount section of the stem 87 may be formed by the operation of cutting away a portion of the bottom surface of the center mount section of the stem 86. The shelf of the center mount section of the stem 87 may be an edge, where the edge may be non-linear, the edge being substantially perpendicular to the bottom surface of the center mount section of the stem 86. In some embodiments, the shelf of the center mount portion of the stem 87 may limit the rotation of the handlebar mount 6 about the center mount pin 12, the shelf of the center mount portion of the stem 87 limiting the rotation of the handlebar mount 6 about the center mount pin 12 between a first position and a second position, wherein the first position comprises the longitudinal axis of the handlebar mount 61 being aligned with the of the stem longitudinal axis 95 at a certain angle of incidence of the two axes, and wherein the second position comprises the longitudinal axis of the handlebar mount 61 rotated to a different angle of incidence relative to the stem longitudinal axis 95.

Those with skill in the art will recognize that “substantially perpendicular,” as it relates to the shelf of the center mount section of the stem 87 and the bottom surface of the center mount section of the stem 86, may not mean “exactly perpendicular” (i.e. 90 degrees), and that in fact any angle of incidence between the shelf of the center mount section of the stem 87 and the bottom surface of the center mount section of the stem 86 which sufficiently limits the rotation of the handlebar mount 6 about the center mount pin 12 may be “substantially perpendicular,” including, for example and without limitation, a 75 degree angle, a 60 degree angle, a 30 degree angle, a 105 degree angle or a 120 degree angle. Other means of limiting the rotation of the handlebar mount 6 may exist, such as one or more pins in the bottom surface of the center mount section of the stem 86, or magnets, or a limiting mechanism associated with the center mount pin 12 or other means, and all such means of limiting the rotation of the handlebar mount are encompassed within the scope of this application.

In some embodiments, a center mount section of the stem 82 may have a tension channel 93. A tension channel 93 may be configured for receiving a tension device 14, a tension coupling of the stem 94, and a tension coupling of the handlebar mount 64 (14 and 64 not shown in FIG. 3a or 3b: 14 is shown in FIGS. 7a and 7b; 64 is shown in FIGS. 4a, 4b and 4d). A tension device 14 may be disposed within the tension channel 93, and coupled to the tension coupling of the stem 94 and the tension coupling of the handlebar mount 64. In some embodiments, when a stem 8 is coupled with a handlebar mount 6 using a center mount pin 12, a tension device 14 may tensionally bias the handlebar mount 6 to rotate about the center mount pin 12, the tension device 14 being coupled with a tension coupling on the stem 8 and a tension coupling on the handlebar mount 6. In some embodiments, a tension coupling on the stem 8 is a stem tension coupling 94, where the stem tension coupling 94 may be a pin disposed within the tension channel 93. In some embodiments, a tension coupling on the handlebar mount 6 is a handlebar mount tension coupling 64, where the handlebar mount tension coupling 64 may be a pin disposed on a surface of the handlebar mount 6. In some embodiments, a tension device 14 may be an elastic band 51, a first end of the elastic band being coupled with the stem tension coupling 94 and a second end of the elastic band being coupled with the handlebar mount tension coupling 64. (The tension device 14, elastic band 51, tension couplings and rotation are discussed further herein with respect to FIGS. 7a and 7b.) In some embodiments, the stem tension coupling 94 and the handlebar mount tension coupling 64 are hooks. In different embodiments, the stem tension coupling 94 and the handlebar mount tension coupling 64 are small apertures drilled in an interior wall of the stem 8 and the handlebar mount 6, the small apertures configured for receiving at least a portion of a tension device 14. In some embodiments, a tension device 14 is an extension spring, the extension spring having a hook at each end, the hook at each end being coupled to the small apertures configured for receiving at least a portion of a tension device 14. It will be understood by those with skill in the art that many combinations of tension device 14 and tension couplings exist, each combination serving to tensionally bias the rotation of the handlebar mount 6 about the center mount pin 12 such that the handlebar mount 6 rotates relative to the stem 8, and all such combinations are disclosed within this application.

In some embodiments, a tension channel 93 may be an arcuate channel in the bottom surface of the center mount section of the stem 86. In different embodiments, a tension channel may be in a different surface of the stem 8. In still different embodiments, a tension channel may be in a surface of the handlebar mount 6. In some embodiments, a tension device that tensionally biases the handlebar mount 6 to rotate about the center mount pin 12 will facilitate one-handed operation, as once the lock pin 16 is operated the apparatus for mounting a handlebar 2 will rotate the handlebar 4 under tension from the tension device 14. In some embodiments, the tension device 14 will have a tendency to rotate the handlebar 4 to a “storage position,” such that if the lock pin 16 is not “locked,” the handlebar 4 will be tensionally biased away from the “riding position,” making storage or carrying of the vehicle 5 easier with the handlebar 4 biased out of the way in a hands-free manner. In such embodiments, a visual cue is provided for safety, in that if the handlebar 4 is not in the “riding position,” a user will notice that the handlebar 4 is being biased away from the “riding position” before attempting to operate the vehicle 5, and can return the handlebar 4 to the “riding position” and positively engage the lock pin 16 before attempting to operate the vehicle 5.

In some embodiments, a center mount section of the stem 82 may have a lock pin channel 89. A lock pin channel 89 may be configured for receiving at least a portion of a lock pin 16. In some embodiments, a lock pin channel 89 may be an arcuate channel. Particularly, when the handlebar mount 6 is rotated about the center mount pin 12, a portion of the lock pin 16 may slide inside the lock pin channel 89. In some embodiments, a lock pin 16 may be tensionally biased to engage with a portion of the lock pin channel 89 (the tensionally biased lock pin discussed further regarding FIG. 4h). In some embodiments, a lock pin channel may have various preferred positions with which a lock pin 16 may engage. In some embodiments, at a first end of a lock pin channel 89, the lock pin channel 89 may be deeper, the deeper portion of the lock pin channel forming a riding position lock hole 90. Upon rotation of the handlebar mount 6 such that the lock pin 16 is over the first end of the lock pin channel 89, the tensionally biased lock pin 16 may engage the riding position lock hole 90. In additional embodiments, at a second end of a lock pin channel 89, the lock pin channel 89 may be deeper, the deeper portion of the lock pin channel forming a storage position lock hole 91. Upon rotation of the handlebar mount 6 such that the lock pin 16 is over the second end of the lock pin channel 89, the tensionally biased lock pin 16 may engage the storage position lock hole 91. Tensionally biasing the lock pin 16 to engage preferred portions of the lock pin channel 89 facilitates one-handed operation of the apparatus for mounting a handlebar 2, in that the handlebar 4 can be rotated using a single hand to a “preferred position,” the lock pin 16 engaging without further intervention. In some embodiments, the lock pin 16 engages lock holes in the lock pin channel at preferred positions of the lock pin channel 89. In different embodiments, the lock pin 16 engages preferred positions of the lock pin channel 89 using magnets instead of lock holes. In different embodiments, the lock pin 16 engages preferred positions of the lock pin channel 89 using gears or other mechanical mechanisms. In different embodiments, the lock pin 16 engages preferred positions of the lock pin channel 89 using a channel configuration other than an arcuate channel including, for example, a channel with additional lateral cutouts forming preferred positions of the lock pin channel 89. In different embodiments, the lock pin channel 89 is disposed within the handlebar mount 6 with the lock pin 16 disposed within the stem 8.

In some embodiments, a lock pin channel 89 may have a ramp 92. A ramp 92 may be a portion of the lock pin channel 89 disposed between the riding position lock hole 90 and the storage position lock hole 91. In some embodiments, a ramp 92 may be a portion of the lock pin channel 89 disposed between the ends of the lock pin channel 89 where the depth of the lock pin channel 89 has a slope. That is, at one end of the ramp 92 the depth of the lock pin channel 89 may have a first depth, and at the other end of the ramp 92 the depth of the lock pin channel may have a second depth. In embodiments having a riding position lock hole 90 and/or storage position lock hole 91, the channel may have yet additional depths. However, the ramp portion of the lock pin channel 89 may have a depth that varies along the ramp 92, the depth varying from shallowest adjacent to the riding position lock hole 90 to deepest adjacent to the storage position lock hole 91. In some embodiments, the varied depth of the ramp 92, combined with the tensionally biased lock pin 16 and tension device 14, may have a tendency to further tensionally bias the rotation of the handlebar mount 6 about the center mount pin 12. In some embodiments, when the lock pin 16 is operated by a user and the handlebar 4 is rotated slightly, the ramp 92 combined with the tensionally biased lock pin 16 and tension device 14 may have a tendency to rotate the handlebar mount 6 about the center mount pin 12 without user intervention. In some embodiments, the rotation may occur until the handlebar mount 6 is rotated to a “storage position,” the tensionally biased lock pin 16 snapping into place in the storage position lock hole 91. In such embodiments, a handlebar 4 can be moved smoothly and easily into a “storage position” using at least a single hand (if not no hands) of the operator, where the handlebar 4 engages firmly into the “storage position” upon the rotation of the handlebar 4 reaching the “storage position,” the “storage position” being delimited by a portion of the shelf of the center mount section of the stem 87. Further, the combined tensioning of the tensionally biased lock pin 16 and tension device 14 and the ramp 92 causes the handlebar 4 to have a tendency to move to the “storage position” by itself if the handlebar 4 is not locked into a “riding position,” which provides added safety for an operator who will receive a visual cue that the vehicle 5 is not ready for operation because the handlebar 4 will be “moving itself” into the “storage position.” Additionally, in some embodiments, the combination facilitates easier storage and/or carriage of the vehicle 5 with the handlebar 4 biased to the “storage position.” In some embodiments, the combination of the varied-depth lock pin channel 89 and tensionally biased lock pin 16 may facilitate one-handed operation such that a user can easily turn an “unlocked” handlebar 4 towards the “storage position” with a single hand, but for safety require two hands to rotate the handlebar 4 to the “riding position.” The discussion of the tensionally biased lock pin 16 and preferred positions of the lock pin channel 89 continues with respect to FIG. 4h, below.

FIG. 4a is an exploded perspective view of an apparatus for mounting a handlebar or handlebars, in accordance with an embodiment of the invention. FIG. 4b is a perspective view of an apparatus for mounting a handlebar or handlebars, in accordance with an embodiment of the invention. FIG. 4c is a top view of an apparatus for mounting a handlebar or handlebars, in accordance with an embodiment of the invention. FIG. 4d is an exploded perspective view of an apparatus for mounting a handlebar or handlebars, in accordance with an embodiment of the invention. FIG. 4e is an exploded side view of an apparatus for mounting a handlebar or handlebars, in accordance with an embodiment of the invention. FIG. 4f is an exploded bottom view of an apparatus for mounting a handlebar or handlebars, in accordance with an embodiment of the invention. FIG. 4g is a bottom view of an apparatus for mounting a handlebar or handlebars, in accordance with an embodiment of the invention. FIG. 4h is a sectional view of an apparatus for mounting a handlebar or handlebars, in accordance with an embodiment of the invention. As may be most easily seen in FIG. 4c, in some embodiments, an apparatus for mounting a handlebar 2 may have a handlebar mount 6, the handlebar mount 6 having a center mount section of the handlebar mount 62, a handlebar section of the handlebar mount 63, and a handlebar mount longitudinal axis 61, the handlebar mount longitudinal axis 61 extending from the center mount section of the handlebar mount 62 through the handlebar section of the handlebar mount 63.

FIG. 4e is an exploded side view of an apparatus for mounting a handlebar or handlebars, in accordance with an embodiment of the invention. FIG. 4f is an exploded bottom view of an apparatus for mounting a handlebar or handlebars, in accordance with an embodiment of the invention. FIG. 4g is a bottom view of an apparatus for mounting a handlebar or handlebars, in accordance with an embodiment of the invention.

As may be best seen in FIG. 4e, in some embodiments, a center mount section of the handlebar mount 62 may have a top portion of the center mount section of the handlebar mount 70 and a bottom portion of the center mount section of the handlebar mount 72. As can be seen most clearly in FIGS. 4e, 4f and 4g (FIGS. 4e and 4f showing the stem 8 and handlebar mount 6 separated, FIGS. 1b and 4g showing them combined), in some embodiments, the center mount section of the handlebar mount 62 is configured for receiving at least a portion of the center mount section of the stem 82. In some embodiments, at least a portion of the center mount section of the stem 82 may fit in between a top portion of the center mount section of the handlebar mount 70 and a bottom portion of the center mount section of the handlebar mount 72. Particularly, when the center mount section of the handlebar mount 62 receives a portion of the center mount section of the stem 82, the bottom portion of the center mount section of the handlebar mount 72 may be disposed adjacent to the shelf 87 of the stem 8.

Returning to FIG. 4a, a top portion of the center mount section of the handlebar mount 70 may have a center pin through hole of the top portion of the center mount section of the handlebar mount 71 disposed through the top portion of the center mount section of the handlebar mount 70. A bottom portion of the center mount section of the handlebar mount may have a center pin through hole of the bottom portion of the center mount section of the handlebar mount 73 disposed through the bottom portion of the center mount section of the handlebar mount 72. In such embodiments, the center pin through hole disposed through the stem 88 aligns with the two center pin through holes disposed through the handlebar mount, 71 and 73, permitting a center mount pin 12 to pass through and rotatably couple the stem 8 and handlebar mount 6, as can be seen in FIG. 1b.

In some embodiments, a handlebar section of the handlebar mount 63 may include a tubular member for receiving a handlebar 80, as seen in FIG. 4b. Turning to FIG. 4d, in some embodiments, a handlebar section of the handlebar mount 63 may include a first portion of the handlebar mount 75, the first portion of the handlebar mount 75 being adjacent to the center mount section of the handlebar mount 62, the first portion of the handlebar mount 75 having a recess of the first portion of the handlebar mount 76, the recess of the first portion of the handlebar mount 76 for receiving at least a portion of a handlebar 4. A handlebar section of the handlebar mount 63 may also include a second portion of the handlebar mount 77, the second portion of the handlebar mount 77 disposed opposite to the first portion of the handlebar mount 75, the second portion of the handlebar mount 77 having a recess of the second portion of the handlebar mount 78, the recess of the second portion of the handlebar mount 78 for receiving at least a portion of a handlebar 4. The first portion of the handlebar mount 75 and the second portion of the handlebar mount 77 may together form a tubular member for receiving a handlebar 80. The first portion of the handlebar mount 75 and the second portion of the handlebar mount 77 may be joined by one or more handlebar mount fasteners 79, the one or more handlebar mount fasteners 79 operable to reduce the diameter of the tubular member for receiving a handlebar 80 when the one or more fasteners 79 are fastened. In different embodiments, the tubular member for receiving a handlebar 80 may have a single portion, where one or more lugs configured to receive one or more fasteners are operable to reduce the diameter of the tubular member when one or more fasteners are received by the one or more lugs. Those with skill in the art will recognize that other means exist for securing a handlebar 4 to a handlebar section of the handlebar mount 63, and all such means are encompassed within the scope of the instant application.

In some embodiments, a center mount section of the handlebar mount 62 may have a lock pin 16. As seen in FIG. 4a, in some embodiments, the lock pin 16 is comprised of the lock pin pull 66, lock pin shaft 67, lock pin compression spring 68, and lock pin endcap 69. A lock pin pull 66 may be a knob, the lock pin pull threading onto a lock pin shaft 67. It will be realized by those with skill in the art that many structures are possible for a lock pin pull, comprising any mechanism suitable to apply force against the tensional bias of the lock pin 16, and all such mechanisms are encompassed within the application. It will be realized by those with skill in the art that many compression devices may provide tensional bias to a lock pin 16, and such compression devices may include a lock pin compression spring 68 as disclosed herein. Other such devices may be include a split washer, a rubber ring, a spring washer, or any other device which has a tendency to become shorter when loaded, and all are included within the scope of this disclosure.

In some embodiments, the lock pin shaft 67 passes through the lock pin enclosure 74 from above the lock pin enclosure 74. In some embodiments, a lock pin compression spring 68 is passed over a lock pin shaft 67 from underneath the lock pin enclosure 74, followed by a lock pin endcap 69 being threaded onto the end of the lock pin shaft 67 opposite the lock pin pull 66. Thus, as can be seen in FIG. 4h, a lock pin end cap 69 may retain the lock pin shaft 67 of the lock pin 16 through the lock pin enclosure 74. The lock pin end cap 69 then engages with a lock pin channel 89 of the stem 8, when the stem 8 is coupled with the handlebar mount 6.

Particularly, in some embodiments, the lock pin compression spring 68 which encircles the lock pin shaft 67 is disposed in between the lock pin enclosure 74 and the lock pin end cap 69. The lock pin compression spring 68 has a tendency to keep the lock pin 16 engaged with the lock pin channel 89 of the stem 8. When the lock pin pull 66 is pulled, the lock pin compression spring 68 compresses, acting against the force of the lock pin pull 66 being pulled, and disengaging the lock pin endcap 69 at least partially from the lock pin channel 89. In some embodiments, pulling the lock pin pull 66 may provide sufficient force to disengage the lock pin 16 from a preferred position of the lock pin channel 89, a preferred position of the lock pin channel 89 being, for example, the riding position lock hole 90 or the storage position lock hole 91. When the lock pin pull 66 is released, the spring tension of the lock pin compression spring causes the lock pin compression spring 68 to uncompress, having a tendency to draw the lock pin 16 back into the lock pin enclosure 74 such that the lock pin 16 engages the lock pin channel 89. If the handlebar 4 has been rotated following pulling the lock pin pull 66, the handlebar may be rotated using a single hand to a preferred position. With lock pin pull 66 released, when the handlebar 4 is rotated to a preferred position, the lock pin 16 may snap into place, the snapping into place occurring because of the tensional bias provided to the lock pin 16 by the lock pin compression spring 68. Further discussion of the preferred positions of the lock pin channel 89 and tensional bias of the lock pin 16 is found with respect to FIGS. 3d, 3e and 3f, above.

FIG. 5a is a perspective view of an alternate embodiment of apparatus for mounting a handlebar or handlebars, in accordance with an embodiment of the invention. FIG. 5b is a side view of an alternate embodiment of apparatus for mounting a handlebar or handlebars, in accordance with an embodiment of the invention. In an alternate embodiment, an apparatus for mounting a handlebar 2 may have a stem 8 and a handlebar mount 6 to facilitate a different direction of travel of the lock pin 16, the lock pin 16 comprised of the lock pin pull 66, the lock pin shaft 67, the lock pin compression spring 68, and the lock pin endcap 69. Particularly, in some embodiments, such as those pictured in FIGS. 1a through 4h, a lock pin may have a vertical direction of travel relative to the vehicle 5, but in an alternate embodiment, a lock pin 16 may have a horizontal direction of travel relative to the vehicle 5. In such an embodiment, a lock pin pull 66 used in conjunction with a lock pin 16 that is horizontal may have a sculpted look such that the profile of the lock pin pull 66 is aligned in a semi-circular arc with the tubular member 80 of the handlebar section of the handlebar mount 63 when viewed from the side. Such a continuous semi-circular arc may provide at least aerodynamic benefit and a more visually appealing look for the apparatus to performance-minded users. In such an embodiment, the lock pin channel 89 of the stem 8 may be located on a different surface of the stem 8. The engaging of the lock pin 16 with the lock pin channel 89 is the same as disclosed in the embodiments pictured in FIGS. 1a through 4h, with the difference being a different location of the lock pin 16 and the lock pin channel 89.

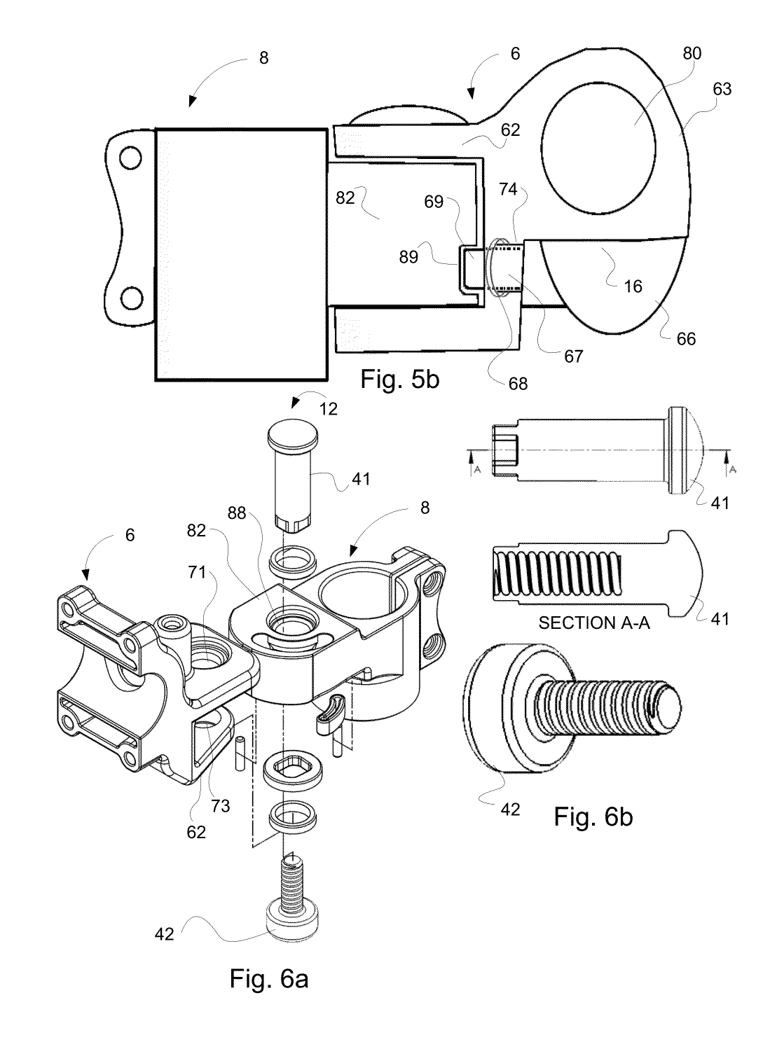

FIG. 6a is an exploded perspective view of an apparatus for mounting a handlebar or handlebars, in accordance with an embodiment of the invention. FIG. 6b is an exploded view of an apparatus for mounting a handlebar or handlebars, in accordance with an embodiment of the invention. In some embodiments, an apparatus for mounting a handlebar 2 includes a center mount pin 12, the center mount pin 12 rotatably coupling the center mount section of the stem 82 and the center mount section of the handlebar mount 62. (The coupling is described further above with regard to FIGS. 3a-3f.) In some embodiments, a center mount pin 12 is comprised of at least an internally threaded pin 41 and a threaded fastener 42. In some embodiments, an internally threaded pin may pass from the top side of the center pin through hole of the top portion of the center mount section of the handlebar mount 71, then through the center pin through hole of the stem 88, then through the center pin through hole of the bottom portion of the center mount section of the handlebar mount 73, emerging from the bottom side of the handlebar mount 6. A threaded fastener 42 may be inserted into the internally threaded pin and tightened, rotatably coupling the stem 8 with the handlebar mount 6. In some embodiments, one or more washers may be deployed with the internally threaded pin 41 and threaded fastener 42 to comprise the center mount pin 12, the washers including one or more square washers. An internally threaded pin 41 may have a smooth shaft exterior and threads on the interior of the internally threaded pin 41, the threads on the interior being configured for receiving a threaded fastener 42. In this manner, a center mount pin 12 is operable to facilitate rotation of the handlebar mount 6 about the center mount pin 12, the internally threaded pin 41 and threaded fastener 42 of the center mount pin 12 also operable to reduce contact between the center mount pin 12 and the stem 8, the center mount pin 12 also operable to reduce contact between the center mount pin 12 and the handlebar mount 6. Reduced contact between a coupling device and the stem 8 and/or handlebar mount 6 provides a safe apparatus for mounting a handlebar 2 in that the components stay coupled throughout constant and lifetime rotation from one position to a different position of the apparatus.

FIGS. 7a and 7b are bottom views of an apparatus for mounting a handlebar or handlebars, in accordance with an embodiment of the invention. In some embodiments, an apparatus for mounting a handlebar 2 may include a tension device 14. In some embodiments, a tension device 14 is an elastic band 51. It will be understood by those with skill in the art that a tension device 14 may be a spring, bungie cord, or any other means of tensionally biasing two parts and all such tension devices are encompassed within the scope of the present disclosure. In some embodiments, an elastic band 51 may be disposed within a tension channel 93 of a stem 8. An elastic band 51 has a first end and a second end, the first end being coupled with the stem 8 at a tension coupling of the stem 94 and the second end being coupled with the handlebar mount 6 at a tension coupling of the handlebar mount 64. In some embodiments, the tension coupling of the stem 94 and the tension coupling of the handlebar mount 64 may be pins, the pins deployed within the tension channel 93. While the tension coupling of the stem 94 is coupled to the stem 8 itself inside the tension channel 93, the tension coupling of the handlebar mount 64 is coupled to the handlebar mount 6 and positioned such that when the stem 8 and handlebar mount 6 are coupled by the center mount pin 12, the tension coupling of the handlebar mount 64 is positioned within the tension channel 93 of the stem 8. The tension coupling of the stem 94 protrudes down into the tension channel (which may be seen more clearly in FIG. 3b), while the tension coupling of the handlebar mount 64 extends upwards from the bottom portion of the center mount section of the handlebar mount 72 (which may be seen in FIGS. 4a and 4b), the extension upwards disposing the tension coupling of the handlebar mount 64 within the tension channel 93 when the handlebar mount 6 and stem 8 are coupled. (FIGS. 4f and 4g may also be helpful for seeing this alignment.)

Returning to FIGS. 7a and 7b, in some embodiments, an elastic band 51 may be at least partially covered by a portion of the handlebar mount 6, such that the elastic band 51 and its operation are hidden from view. Such a configuration may serve to prevent fingers from being pinched by the mechanical components that operate the apparatus for mounting a handlebar 2. Those with skill in the art will understand that the elastic band 51 is deployed within the tension channel 93, the tension channel 93 being at least partially covered by the bottom portion of the center mount section of the handlebar mount 72. While the elastic band 51 is fully shown in FIGS. 7a and 7b, this depiction is for operational understanding only and in the present embodiment at least a portion of the elastic band 51 may not be visible, being hidden underneath the bottom portion of the center mount section of the handlebar mount 72.

In some embodiments, the elastic band 51, being looped around the tension coupling of the stem 94 and the tension coupling of the handlebar mount 64, and being disposed within the arcuate tension channel 93, will have a tendency to rotate the handlebar mount 6 relative to the stem 8. As can be seen in FIG. 7a, the elastic band 51 is stretched, and the longitudinal axes of the stem 8 and handlebar mount 6 are aligned. As discussed and depicted elsewhere herein, in some embodiments a lock pin 16 may be configured to lock the handlebar mount 6 in this position. As can be seen in FIG. 7b, the elastic band 51 has rotated the handlebar mount 6 relative to the stationary stem 8.

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. An apparatus for mounting handlebars, comprising:
a stem, the stem comprising:
a clamp section of the stem;
a center mount section of the stem; and
a stem longitudinal axis, the stem longitudinal axis extending from the clamp section of the stem through the center mount section of the stem;
a handlebar mount, the handlebar mount comprising:
a center mount section of the handlebar mount;
a handlebar section of the handlebar mount for receiving handlebars;
a lock pin of the handlebar mount, the lock pin of the handlebar mount being operable to engage at least a portion of the stem; and
a handlebar mount longitudinal axis, the handlebar mount longitudinal axis extending from the center mount section of the handlebar mount through the handlebar section of the handlebar mount;
a center mount pin, the center mount pin rotatably coupling the center mount section of the stem and the center mount section of the handlebar mount; and
a tension device, the tension device tensionally biasing the stem and handlebar mount to rotate the handlebar mount about the center mount pin.

2. The apparatus of claim 1, wherein the clamp section of the stem comprises:
a tubular member, the tubular member configured to receive a steering tube of a bicycle, the tubular member being split; and
one or more lugs, the one or more lugs configured to receive one or more fasteners, the one or more lugs being operable to reduce the diameter of the tubular member when one or more fasteners are received by the one or more lugs.

3. The apparatus of claim 1, wherein the center mount section of the stem comprises:
a top surface of the center mount section;
a bottom surface of the center mount section, the bottom surface of the center mount section having a cutaway portion;
a shelf, the shelf being the surface exposed by the cutaway portion of the bottom surface of the center mount section;
a center pin through hole, the center pin through hole being disposed from the top surface of the center mount section to the bottom surface of the center mount section;
a lock pin channel, the lock pin channel being cut into a surface of the center mount section, the lock pin channel having a deeper cut at a first end of the lock pin channel, the deeper cut at the first end of the lock pin channel being configured for receiving the lock pin of the handlebar mount, the deeper cut at the first end of the lock pin channel being aligned with the stem longitudinal axis, the deeper cut at the first end of the lock pin channel that is aligned with the stem longitudinal axis forming a riding position lock hole;
a tension channel, the tension channel being cut into a surface of the center mount section; and
a stem tension coupling, the stem tension coupling being disposed within the tension channel.

4. The apparatus of claim 3, wherein the center mount section of the handlebar mount is configured for receiving at least a portion of the center mount section of the stem.

5. The apparatus of claim 4, wherein the center mount section of the handlebar mount comprises:
a top portion of the center mount section of the handlebar mount, the top portion of the center mount section of the handlebar mount having a through hole disposed through the top portion of the center mount section of the handlebar mount, the through hole configured for receiving the center mount pin; and
a bottom portion of the center mount section of the handlebar mount, the bottom portion of the center mount section of the handlebar mount having a through hole disposed through the bottom portion of the center mount section of the handlebar mount, the through hole configured for receiving the center mount pin, the bottom portion of the center mount section of the handlebar mount having a handlebar mount tension coupling, the handlebar mount tension coupling configured to be received by the tension channel of the center mount section of the stem.

6. The apparatus of claim 5, wherein the tension device is an elastic band, the elastic band being coupled to the stem tension coupling and the handlebar mount tension coupling.

7. The apparatus of claim 6, wherein the lock pin channel has a deeper cut at a second end of the lock pin channel, the deeper cut at the second end of the lock pin channel being configured for receiving the lock pin of the handlebar mount, the deeper cut at the second end of the lock pin channel forming a storage position lock hole.

8. The apparatus of claim 7, wherein the portion of the lock pin channel between the riding position lock hole and the storage position lock hole forms a ramp between the riding position lock hole and the storage position lock hole, the ramp being shallowest adjacent to the riding position lock hole and the ramp being deepest adjacent to the storage position lock hole.

9. The apparatus of claim 5, wherein the shelf limits the rotation of the handlebar mount about the center mount pin, wherein the shelf limits the rotation of the handlebar mount about the center mount pin between a first position and a second position, wherein the first position comprises the longitudinal axis of the handlebar mount being aligned with the longitudinal axis of the stem, and wherein the second position comprises the longitudinal axis of the handlebar mount rotated to a non-zero angle relative to the longitudinal axis of the stem, and wherein the lock pin of the handlebar mount at least engages the riding position lock hole of the stem when the handlebar mount is in the first position.

10. The apparatus of claim 1 wherein the handlebar section of the handlebar mount comprises:
a first portion, the first portion being adjacent to the center mount section of the handlebar mount, the first portion having a recess for receiving at least a portion of a handlebar; and
a second portion, the second portion disposed opposite to the first portion, the second portion having a recess for receiving at least a portion of a handlebar;
wherein the recess of the first portion and the recess of the second portion together form a tubular member for receiving a handlebar, and wherein the first portion and the second portion are joined by one or more fasteners, the fasteners operable to reduce the diameter of the tubular member for receiving a handlebar when the one or more fasteners are fastened.

11. The apparatus of claim 1 wherein the handlebar section of the handlebar mount comprises:
a tubular member, the tubular member configured for receiving a handlebar; and
one or more lugs, the one or more lugs configured to receive one or more fasteners, the one or more lugs being operable to reduce the diameter of the tubular member when one or more fasteners are received by the one or more lugs.

12. The apparatus of claim 1 wherein the center mount pin is internally threaded, and wherein the center mount pin is configured for receiving a threaded fastener, the center mount pin having a smooth exterior shaft, the center mount pin and threaded fastener operable to rotatably couple the handlebar mount and the stem, the center mount pin and threaded fastener operable to facilitate rotation of the handlebar mount about the center mount pin, the center mount pin and threaded fastener operable to reduce contact between the smooth exterior shaft of the center mount pin and the stem, the center mount pin and threaded fastener operable to reduce contact between the smooth exterior shaft of the center mount pin and the handlebar mount.

13. The apparatus of claim 1 wherein the lock pin of the handlebar mount is tensionally biased by a compression device, the tensionally biased compression device being operable to engage the lock pin with at least a portion of the stem.

14. An apparatus for mounting handlebars, comprising:
a stem, the stem comprising:
a clamp section of the stem, the clamp section of the stem comprising:
a tubular member, the tubular member configured to receive a steering tube of a bicycle, the tubular member being split; and
one or more lugs, the one or more lugs configured to receive one or more fasteners, the one or more lugs being operable to reduce the diameter of the tubular member when one or more fasteners are received by the one or more lugs;
a center mount section of the stem, the center mount section of the stem comprising:
a top surface of the center mount section;
a bottom surface of the center mount section, the bottom surface of the center mount section having a cutaway portion;
a shelf, the shelf being the surface exposed by the cutaway portion of the bottom surface of the center mount section;
a center pin through hole, the center pin through hole being disposed from the top surface of the center mount section to the bottom surface of the center mount section;
a lock pin channel, the lock pin channel being cut into a surface of the center mount section, the lock pin channel having a deeper cut at a first end of the lock pin channel, the deeper cut at the first end of the lock pin channel being configured for receiving the lock pin of the handlebar mount, the deeper cut at the first end of the lock pin channel being aligned with the stem longitudinal axis, the deeper cut at the first end of the lock pin channel that is aligned with the stem longitudinal axis forming a riding position lock hole, the lock pin channel having a deeper cut at a second end of the lock pin channel, the deeper cut at the second end of the lock pin channel being configured for receiving the lock pin of the handlebar mount, the deeper cut at the second end of the lock pin channel forming a storage position lock hole;
a tension channel, the tension channel being cut into a surface of the center mount section; and
a stem tension coupling, the stem tension coupling being disposed within the tension channel; and
a stem longitudinal axis, the stem longitudinal axis extending from the clamp section of the stem through the center mount section of the stem;
a handlebar mount, the handlebar mount comprising:
a center mount section of the handlebar mount, the center mount section of the handlebar mount comprising:
a top portion of the center mount section of the handlebar mount, the top portion of the center mount section of the handlebar mount having a through hole disposed through the top portion of the center mount section of the handlebar mount, the through hole configured for receiving the center mount pin; and
a bottom portion of the center mount section of the handlebar mount, the bottom portion of the center mount section of the handlebar mount having a through hole disposed through the bottom portion of the center mount section of the handlebar mount, the through hole configured for receiving the center mount pin, the bottom portion of the center mount section of the handlebar mount having a handlebar mount tension coupling, the handlebar mount tension coupling configured to be received by the tension channel of the center mount section of the stem;
wherein the center mount section of the handlebar mount is configured for receiving at least a portion of the center mount section of the stem
a handlebar section of the handlebar mount for receiving handlebars, the handlebar section of the handlebar mount for receiving handlebars comprising:
a tubular member, the tubular member configured for receiving a handlebar; and
one or more lugs, the one or more lugs configured to receive one or more fasteners, the one or more lugs being operable to reduce the diameter of the tubular member when one or more fasteners are received by the one or more lugs;
a lock pin of the handlebar mount, the lock pin of the handlebar mount being operable to engage at least a portion of the stem wherein the lock pin of the handlebar mount is tensionally biased by a compression device, the tensionally biased compression device being operable to engage the lock pin with at least a portion of the stem; and
a handlebar mount longitudinal axis, the handlebar mount longitudinal axis extending from the center mount section of the handlebar mount through the handlebar section of the handlebar mount;
a center mount pin, the center mount pin rotatably coupling the center mount section of the stem and the center mount section of the handlebar mount, wherein the center mount pin is internally threaded, wherein the center mount pin has a smooth exterior shaft, and wherein the center mount pin is configured for receiving a threaded fastener, the center mount pin and threaded fastener operable to rotatably couple the handlebar mount and the stem, the center mount pin and threaded fastener operable to facilitate rotation of the handlebar mount about the center mount pin, the center mount pin and threaded fastener operable to reduce contact between the smooth exterior shaft of the center mount pin and the stem, the center mount pin and threaded fastener operable to reduce contact between the smooth exterior shaft of the center mount pin the handlebar mount; and
an elastic band, the elastic band coupled to the stem tension coupling and handlebar mount tension coupling, the elastic band tensionally biasing the stem and handlebar mount to rotate the handlebar mount about the center mount pin.

15. An apparatus for mounting handlebars, comprising:
a means for mounting to a steering mechanism of a vehicle;
a means for receiving a handlebar;
a means for rotatably coupling the means for receiving a handlebar to the means for mounting to a steering mechanism of a vehicle;
a means for tensionally biasing the means for receiving a handlebar and the means for mounting to a steering mechanism of a vehicle, wherein the means for tensionally biasing rotates the means for receiving a handlebar relative to the means for mounting to a steering mechanism of a vehicle;
a means for limiting the rotation of the means for receiving a handlebar relative to the means for mounting to a steering mechanism of a vehicle;
a means for locking the means for mounting to a steering mechanism of a vehicle to the means for receiving a handlebar, wherein when the locking means is engaged, the vehicle can at least be steered; and
a means for tensionally biasing the means for locking the means for mounting to a steering mechanism of a vehicle to the means for receiving a handlebar, wherein where the means for receiving a handlebar is rotated relative to the means for mounting to a steering mechanism of a vehicle, the rotation rotating to a preferred position, the means for tensionally biasing the means for locking engages.
